(19) United States
(12) Patent Application Publication
(10) Pub. No.: US 2024/0095751 A1
(43) Pub. Date: Mar. 21, 2024

(54) AUTOMATICALLY PREDICTING DISPATCH-RELATED DATA USING MACHINE LEARNING TECHNIQUES

(71) Applicant: Dell Products L.P., Round Rock, TX (US)

(72) Inventors: Divya Maddi, Round Rock, TX (US); Hung T. Dinh, Austin, TX (US); Bijan Kumar Mohanty, Austin, TX (US)

(21) Appl. No.: 17/947,369

(22) Filed: Sep. 19, 2022

(51) Int. Cl. G06Q 30/00; G06N 3/04

(52) U.S. Cl. CPC G06Q 30/016; G06N 3/0481

(57) ABSTRACT

Methods, apparatus, and processor-readable storage media for automatically predicting dispatch-related data using machine learning techniques are provided herein. An example computer-implemented method includes obtaining data, from one or more user channels, pertaining to at least one issue; determining, based at least in part on the obtained data, that at least one dispatch is to be carried out in connection with attempting to resolve the at least one issue; predicting, by processing at least a portion of the obtained data using one or more machine learning techniques, an approval mode associated with the at least one dispatch and at least one outcome associated with the at least one dispatch; and performing one or more automated actions based at least in part on one or more of the predicted approval mode and the at least one predicted outcome.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to techniques for managing resources using such systems.

### BACKGROUND

The efficacy of product support techniques is commonly not only dependent upon the accurate diagnosis and resolution of an issue, but also on the efficiency of first-time resolution efforts and the time required to resolve the issue. However, conventional support techniques typically involve reliance on static rules which dictate dispatch-related decisions and often result in errors, temporal delays, and/or resource wastage due to return dispatch trips.

### SUMMARY

Illustrative embodiments of the disclosure provide techniques for automatically predicting dispatch-related data using machine learning techniques. An exemplary computer-implemented method includes obtaining data, from one or more user channels, pertaining to at least one issue, and determining, based at least in part on the obtained data, that at least one dispatch is to be carried out in connection with attempting to resolve the at least one issue. The method also includes predicting, by processing at least a portion of the obtained data using one or more machine learning techniques, an approval mode associated with the at least one dispatch and at least one outcome associated with the at least one dispatch. Further, the method includes performing one or more automated actions based at least in part on one or more of the predicted approval mode and the at least one predicted outcome.

Illustrative embodiments can provide significant advantages relative to conventional support techniques. For example, problems associated with errors, temporal delays, and/or resource wastage are overcome in one or more embodiments through automatically predicting dispatch approval modes and dispatch outcomes using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically predicting dispatch-related data using machine learning techniques in an illustrative embodiment.

FIG. 2 shows example system architecture in an illustrative embodiment.

FIG. 3 shows example architecture of an approval mode and dispatch outcome prediction engine in an illustrative embodiment.

FIG. 4 shows example architecture of a multi-output neural network for approval mode and dispatch outcome prediction in an illustrative embodiment.

FIG. 5 shows example pseudocode for implementing data preprocessing techniques in an illustrative embodiment.

FIG. 6 shows example pseudocode for encoding text-based values into numerical values in an illustrative embodiment.

FIG. 7 shows example pseudocode for splitting a dataset into training and testing datasets in an illustrative embodiment.

FIG. 8 shows example pseudocode for creating a neural network model in an illustrative embodiment.

FIG. 9 shows example pseudocode for assembling a neural network model in an illustrative embodiment.

FIG. 10 shows example pseudocode for training, evaluating, and executing a neural network model in an illustrative embodiment.

FIG. 11 is a flow diagram of a process for automatically predicting dispatch-related data using machine learning techniques in an illustrative embodiment.

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

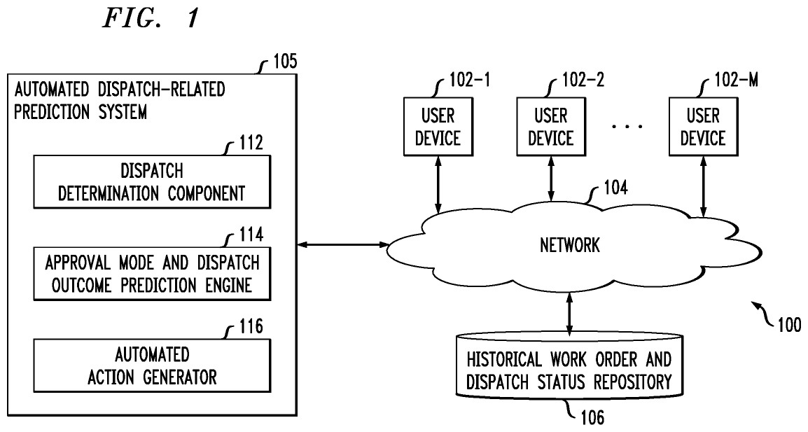

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated dispatch-related prediction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated dispatch-related prediction system 105 can have an associated historical work order and dispatch status repository 106 configured to store historical data related, for example, to case information, work order information, dispatch data, user/customer information, system information, etc.

The historical work order and dispatch status repository 106 in the present embodiment is implemented using one or more storage systems associated with automated dispatch-related prediction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated dispatch-related prediction system 105 are one or more input-output devices, which illustratively comprise keyboards, displays or other types of input-output devices in any combination. Such input-output devices can be used, for example, to support one or more user interfaces to automated dispatch-related prediction system 105, as well as to support communication between automated dispatch-related prediction system 105 and other related systems and devices not explicitly shown.

Additionally, automated dispatch-related prediction system 105 in the FIG. 1 embodiment is assumed to be implemented using at least one processing device. Each such processing device generally comprises at least one processor and an associated memory, and implements one or more functional modules for controlling certain features of automated dispatch-related prediction system 105.

More particularly, automated dispatch-related prediction system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated dispatch-related prediction system 105 to communicate over the network 104 with the user devices 102, and illustratively comprises one or more conventional transceivers.

The automated dispatch-related prediction system 105 further comprises dispatch determination component 112, approval mode and dispatch outcome prediction engine 114, and automated action generator 116.

It is to be appreciated that this particular arrangement of elements 112, 114 and 116 illustrated in the automated dispatch-related prediction system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically predicting dispatch-related data using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated dispatch-related prediction system 105 and historical work order and dispatch status repository 106 can be on and/or part of the same processing platform.

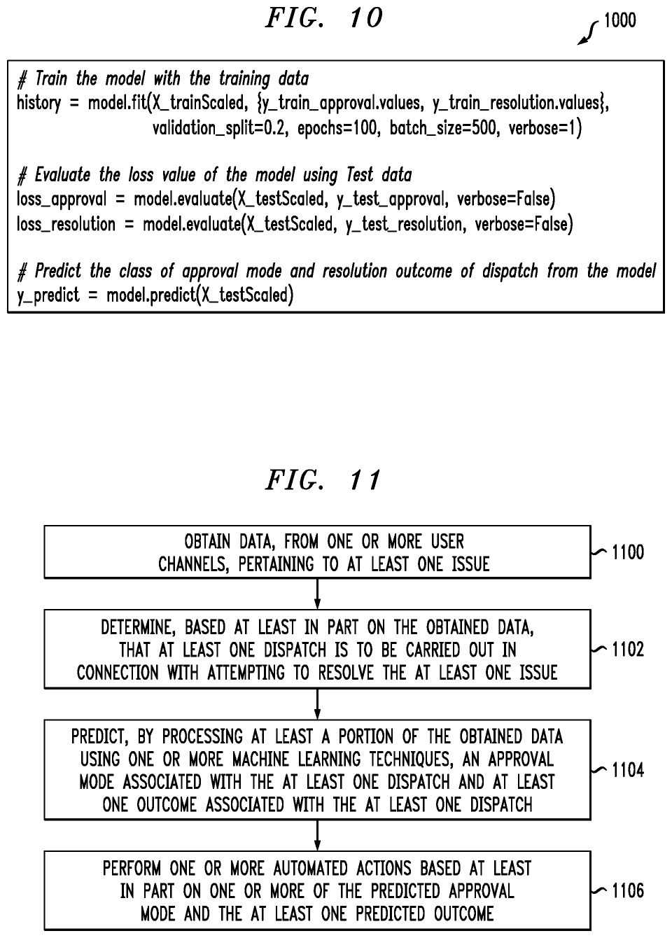

An exemplary process utilizing elements 112, 114 and 116 of an example automated dispatch-related prediction system 105 in computer network 100 will be described in more detail with reference to the flow diagram of FIG. 11.

As used herein, a dispatch refers to a support-related process wherein at least one part and/or at least one technician is implemented to remedy at least one issue (e.g., to fix a defective device). For example, a dispatch can be a parts-only dispatch, wherein at least one new and/or replacement part is sent to a user location wherein the user can replace at least one defective part with the provided part(s). As another example, a dispatch can be a labor-only dispatch, wherein at least one technician is sent to a user location to fix and/or repair at least one defective part. By way of further example, a dispatch can also be a part(s) and labor dispatch, wherein at least one technician is dispatched to a location while at least one new and/or replacement part is also sent to the location so that the technician(s) can replace at least one defective part with the provided part(s).

Accordingly, at least one embodiment includes leveraging machine learning techniques to recommend whether auto-approval or manual review is needed for one or more work orders. In addition, such an embodiment includes predicting if a given work order is sufficient to resolve a given issue, as well as predicting the type(s) of reason(s) that might require one or more return trips. More specifically, one or more embodiments include implementing at least one machine learning model which leverages a multi-target classification algorithm to predict the type of approval (e.g., automatic or manual) for a dispatch as well as the class(es) of the dispatch outcome (e.g., resolved or incorrect diagnosis, defective service parts, etc.). As used herein, a work order is a higher-level process object than a dispatch, in that a work order can, for example, contain multiple dispatches related to remedying at least one issue. Based at least in part on such predictions, at least one customer relationship management (CRM) workflow can either fully automate a field dispatch in the case of an automatic approval and resolved cases, or insert a manual step for review with one or more reasons in the case of unresolved predictions.

At least one machine learning algorithm utilized in one or more embodiments can be trained using historical resolution data. Such historical resolution data can include, for example, information related to features such as product model, operating system, issue type, user(s), business segment, region, type of support (on-site or depot), etc., along with target variables including resolution outcome (fixed or not fixed) and approval mode (automatic or manual). Such a machine learning algorithm can include using a multi-target classifier in connection with predicting one or more attributes of a dispatch workflow (e.g., one or more attributes which will drive the next step(s) in a given dispatch workflow). Such predicted attributes can include, for example, the approval mode for the given dispatch and the outcome of the given dispatch. Based at least in part on the predicted attributes, multiple combinations of determinations can be considered and/or reached which can then drive the next step(s) in the given dispatch workflow. Accordingly, such an intelligent treatment to a dispatch approval workflow as detailed in connection with one or more embodiments can reduce incorrect diagnoses, incorrect part(s) selection(s), etc., as well as reduce return trips of field agents and operational costs of warranty support.

As further described herein, at least one embodiment includes incorporating at least one deep neural network model to build at least one multi-target classifier capable of predicting, for example, if a given field dispatch requires a manual review and/or if the given field dispatch will be able to resolve the original issue (thereby avoiding return trips).

In one or more embodiments, such predictions are achieved by leveraging historical case data, work order data and dispatch data from at least one CRM system (which can include, e.g., attributes of the original issue, initial diagnosis, issue classification, approval method (automatic versus manual), labor and parts dispatched as well as the outcome of the field with one or more corresponding reasons). By considering a multitude of dynamic factors as learned from historical multi-dimensional data (such as obtained from CRM systems), such an embodiment can include accurately predicting the approval method and field dispatch outcome for one or more future work orders. One or more embodiments can then include using such predictions to enable improving the work order workflow and/or dispatch workflow to intelligently add one or more decisions to handle any potential issues in the field (thereby reducing and/or avoiding return trips). By way merely of example, such a decision can include changing the approval mode. For instance, if the model predicts that the issue resolution outcome is “fixed” with an automatic approval, the dispatch can be automatically approved. However, if the model predicts that the issue resolution outcome is “not-fixed” with an automatic approval, one or more embodiments can include sending this dispatch for a manual approval (which, e.g., can potentially remedy and/or prevent a wrong part being dispatched, a wrong diagnosis being made, etc.). If such a dispatch is automatically approved, the dispatch may result in a return trip by a technician. Accordingly, such types of decisions can be determined and/or carried out using insight from the model.

One or more embodiments include obtaining data pertaining to at least one work order, conducting at least one data engineering step on at least a portion of the obtained data, and extracting one or more features and/or independent variables from the data (e.g., issue type, customer/user information, product(s) impacted, initial diagnosis, part(s) to be replaced, region, warranty information, etc.), as well as target variable data (e.g., approval mode, and the outcome of the field dispatch (resolved or reasons for not being resolved). Such extracted information can then be filtered and used to create at least one dataset that can be stored in a historical data repository for future training and analysis. In one or more embodiments, filtering includes removing one or more unnecessary variables and/or features from the dataset. Such filtering can be carried out at the data engineering stage, wherein, for example, only the features that have influence on the target variable are kept in the training dataset while the rest of the other variables are removed. Such filtering helps in reducing the dimensionality of the training data, and improves the performance and accuracy of the model. Further, such a stored filtered dataset can be used, in one or more embodiments, to train a multi-output classification-based deep learning model for dispatch-related predictions, as further detailed herein.

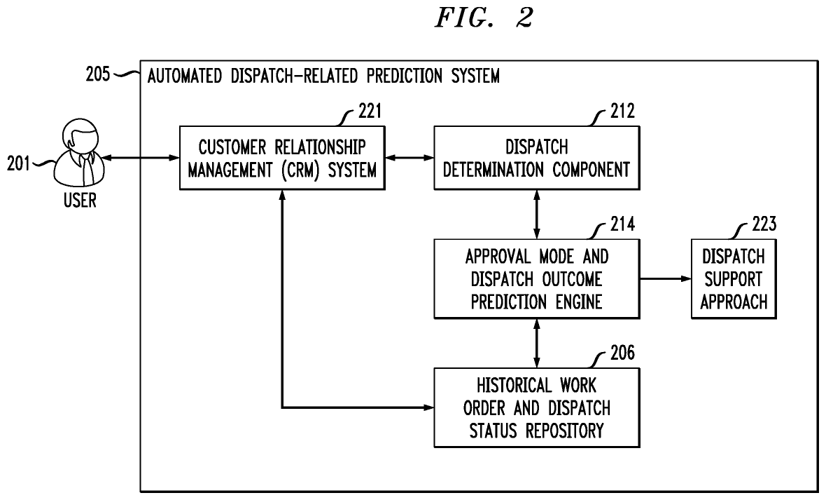

FIG. 2 shows example system architecture in an illustrative embodiment. By way of illustration, FIG. 2 depicts a user 201 (e.g., an enterprise customer) providing information pertaining to one or more issues via various channels (e.g., portal and/or online, phone and/or voice, email, chat, etc.) to automated dispatch-related prediction system 205. Within automated dispatch-related prediction system 205, at least a portion of such provided information is processed, resulting in the creation of at least one incident and/or case in CRM system 221. Each such incident and/or case includes metadata that can include various details such as, for example, user information, product information, issue type and/or class, description of issue, etc., which can be analyzed for diagnosis by dispatch determination component 212.

In one or more embodiments, upon identifying, by dispatch determination component 212, an issue that requires a repair needing labor and/or parts, a work order and dispatch is created. A smart dispatch approval process, carried out by approval mode and dispatch outcome prediction engine 214, involves determining whether the dispatch for field support needs a manual approval or an automatic approval and predicting an optimized dispatch support approach 223 for reducing return trips and maximizing first-time resolution.

As depicted in FIG. 2, and as further detailed herein, one or more embodiments include building and implementing an historical work order and dispatch status repository 206, which contains historical data related, for example, to case information, work order information, dispatch data, etc., which can be obtained and/or provided via one or more systems such as CRM system 221.

In at least one embodiment, data engineering and data preprocessing techniques can be carried out to understand one or more data features and/or one or more data elements that may influence predictions for approval mode and dispatch outcome. Such an embodiment can include implementing one or more multivariate-variate plots and at least one correlation heatmap to identify the significance of each of one or more features in a given dataset, such that certain data elements (e.g., less important data elements) can be filtered out. Based at least in part on such techniques, historical work order and dispatch status repository 206 can contain remaining and/or post-filtering information such as, for example, user information, product model, operating system information, issue classification, type of dispatch (e.g., labor only, parts only, or both), approval mode, and dispatch outcome descriptions (e.g., with one or more reasons related thereto). As depicted in FIG. 2, such information contained within historical work order and dispatch status repository 206 can be used to train at least a portion of the approval mode and dispatch outcome prediction engine 214.

Approval mode and dispatch outcome prediction engine 214 processes input data (e.g., user-provided data associated with a needed dispatch, including case information, work order information, etc.) to predict an optimal approval mode and the outcome of the dispatch. In at least one embodiment, approval mode and dispatch outcome prediction engine 214 leverages at least one supervised learning mechanism and one or more multi-output prediction methods to predict both the approval mode and the outcome of a given dispatch. Further, in such an embodiment, approval mode and dispatch outcome prediction engine 214 can be trained with the same attributes and/or features of historical data (e.g., case information, work order information, dispatch data, etc.) for both target variables.

As noted above and further described herein, important features (e.g., features that may influence the target variables) are extracted from one or more datasets contained within historical work order and dispatch status repository 206, and during a training phase of the approval mode and dispatch outcome prediction engine 214, at least a portion of such features are fed to the approval mode and dispatch outcome prediction engine 214 as independent variables and the actual value(s) of the output (i.e., approval mode and dispatch outcome) are fed to the approval mode and dispatch outcome prediction engine 214 as the dependent values and/or target values.

On receiving a new case or work order, one or more embodiments includes utilizing (e.g., in conjunction with CRM system 221) the trained multi-output classifier-based model in approval mode and dispatch outcome prediction engine 214 to predict the approval mode and outcome of the dispatch at the same time, generating a dispatch support approach 223 based thereon. By way merely of illustration, there are multiple possible results based on the noted predictions, which can include the following:
(i) Mode: Automatic; Outcome: Resolved; Action: Automatically send the dispatch.
(ii) Mode: Automatic; Outcome: Not resolved, with reason(s); Action: Send for manual review of the dispatch with the reason(s) helping in re-diagnosis of the issue(s).
(iii) Mode: Manual; Outcome: Resolved; Action: Automatically send the dispatch.
(iv) Mode: Manual; Outcome; Not resolved, with reason(s); Action: Send for manual review of the dispatch with the reason(s) helping in re-analysis and re-diagnosis of the issue(s).

In one or more embodiments, if the prediction of the dispatch outcome cannot be resolved, but a reason is determined for this status, this reason can be sent to a manual approval process for an agent to verify and potentially re-diagnose the original issue.

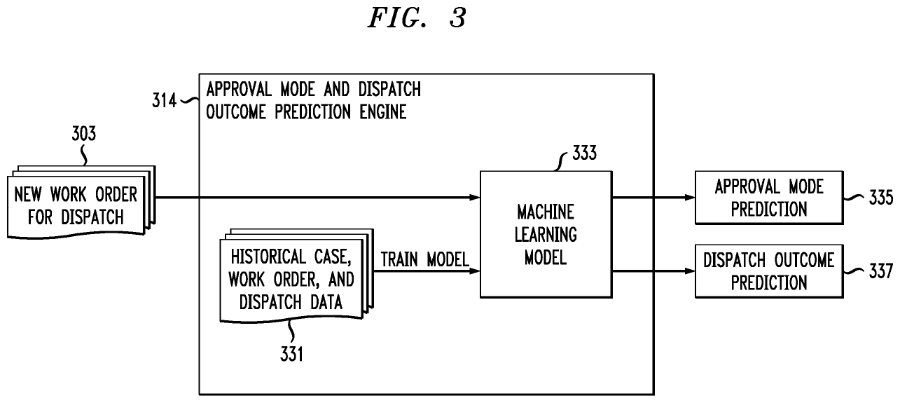

FIG. 3 shows example architecture of an approval mode and dispatch outcome prediction engine in an illustrative embodiment. By way of illustration, FIG. 3 depicts a new work order for a dispatch 303 provided to and/or obtained by approval mode and dispatch outcome prediction engine 314. Specifically, the new work order for a dispatch 303 is processed by a machine learning model 333 (e.g., a multi-output neural network) of approval mode and dispatch outcome prediction engine 314, wherein the machine learning model 333 is trained using historical data 331 (e.g., data derived from an historical work order and dispatch status repository, such as detailed herein, pertaining, for example, to case information, work order information, dispatch data, etc.).

In one or more embodiments, machine learning model 333 includes a multi-output neural network, a deep neural network having two or more parallel branches of a network for two or more types of outputs. By taking the same set of input variables as a single input layer and building a dense, multi-layer neural network, approval mode and dispatch outcome prediction engine 314 can act as a sophisticated classifier for multi-output predictions (such as, for example, an approval mode prediction 335 and a dispatch outcome prediction 337).

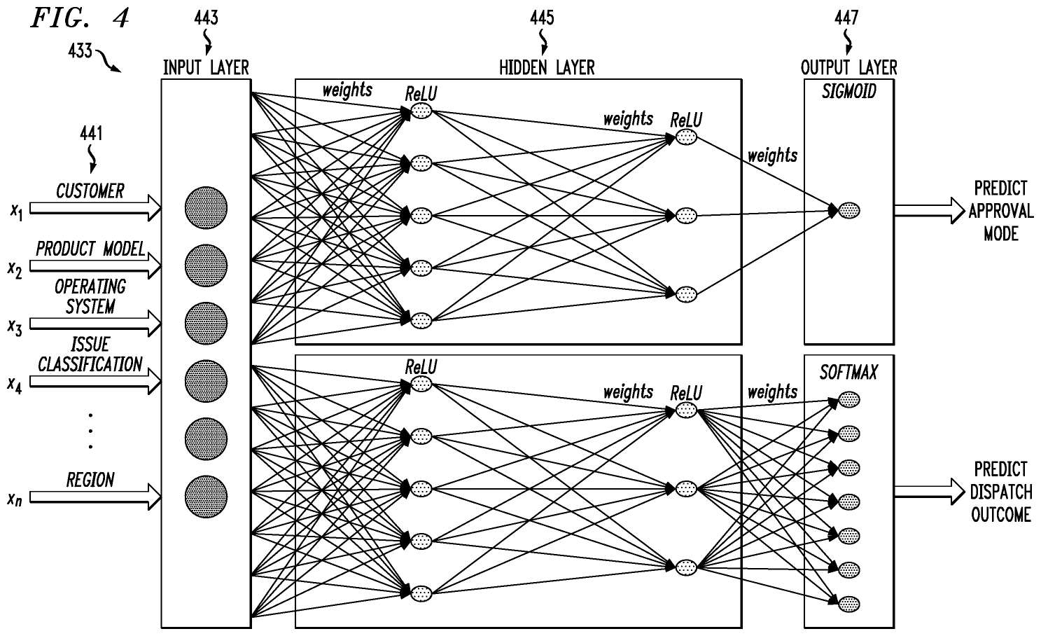

FIG. 4 shows example architecture of a multi-output neural network 433 for approval mode and dispatch outcome prediction in an illustrative embodiment. As illustrated in FIG. 4, multi-output neural network 433 includes an input layer 443 (which processes input data 441 that can include customer information (x₁), product model information (x₂), operating system information (x₃), issue classification information (x₄), region information (xₙ), etc.), one or more (e.g., two) hidden layers 445, and at least one output layer 447. As a multi-output neural network, the multi-output neural network 433 depicted in FIG. 4 creates two separate branches of network (i.e., utilizing hidden layers 445 and output layer(s) 447) that connect to the same input layer 443.

In at least one embodiment, the input layer 443 includes a number of neurons that matches the number of input/independent variables. Also, as noted, the multi-output neural network 433 depicted in FIG. 4 includes two hidden layers 445, and the neuron(s) on each layer depends upon the number of neurons in the input layer 443. The output layer 447 for each branch contains one or more neurons, matching the classes of the prediction associated with the given branch. For example, in the approval mode branch, output layer 447 includes one neuron for two types of approval modes (automatic and manual). Similarly, the number of neurons in the dispatch outcome branch of output layer(s) 447 matches the number of types of outcomes with associated reason(s).

As also depicted in FIG. 4 as merely an example embodiment, neurons in the hidden layer(s) 445 use a rectified linear unit (ReLU) activation function, neurons in the approval mode branch of output layer(s) 447 use a sigmoid activation function (due, e.g., to its nature of being a binary classifier), and neurons in the dispatch outcome branch of output layer(s) 447 use a softmax activation function (e.g., for purposes of that branch serving as a multi-class classifier). In a neural network such as multi-output neural network 433, weights and biases can be applied on each neuron. Such weights and biases can, for example, start with one or more random values upon which calculation of the output is based. When the output value is compared with the target value, based on the difference (e.g., the error), the neural network adjusts the value of the weights and/or biases to perform the calculation again, in a process referred to as backpropagation. Such a process can repeat until the difference (e.g., the error) is minimal and/or at or below a given threshold. At that time, the weights and bias values are deemed the optimal values for the model and are used for generating predictions.

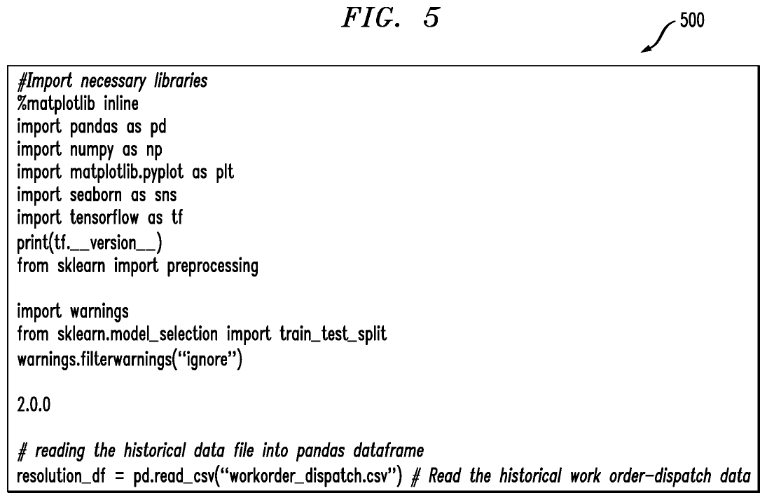

As depicted in FIG. 5 through FIG. 10, the implementation of one or more embodiments can be achieved using, for example, Keras with TensorFlow backend, Python language, Pandas, Numpy and SciKitLearn libraries.

FIG. 5 shows example pseudocode for implementing data preprocessing techniques in an illustrative embodiment. In this embodiment, example pseudocode 500 is executed by or under the control of at least one processing system and/or device. For example, the example pseudocode 500 may be viewed as comprising a portion of a software implementation of at least part of automated dispatch-related prediction system 105 of the FIG. 1 embodiment.

The example pseudocode 500 illustrates data preprocessing techniques which include importing one or more libraries, reading the dataset of the notification request and communication(s) from the historical notification communication repository, and generating a Pandas data frame. The data frame contains columns including independent variables and multiple dependent/target variable columns (e.g., approval mode and outcome with reason(s)). In one or more embodiments, additional preprocessing steps can include handling any null or missing values in the columns. For example, null or missing values in numerical columns can be replaced by the median value of that column. Additionally, after performing data analysis by creating one or more univariate and bivariate plots of the columns, the importance and/or influence of each column can be determined. Columns that have limited importance and/or influence on the actual prediction (e.g., a target variable) can be removed.

It is to be appreciated that this particular example pseudocode shows just one example implementation of data preprocessing techniques, and alternative implementations of the process can be used in other embodiments.

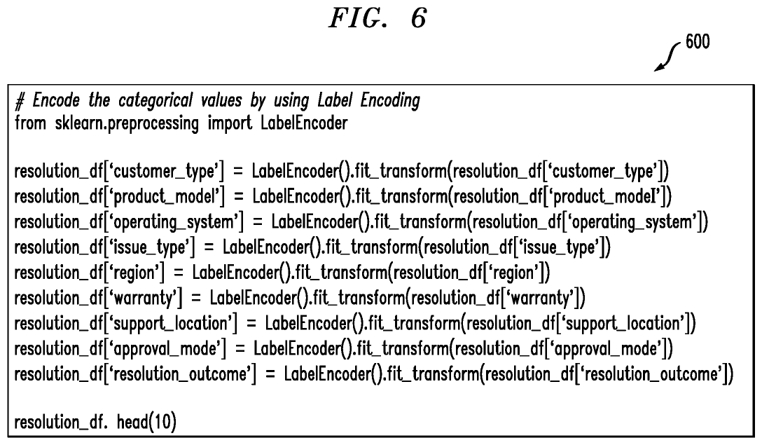

FIG. 6 shows example pseudocode for encoding text-based values into numerical values in an illustrative embodiment. In this embodiment, example pseudocode 600 is executed by or under the control of at least one processing system and/or device. For example, the example pseudocode 600 may be viewed as comprising a portion of a software implementation of at least part of automated dispatch-related prediction system 105 of the FIG. 1 embodiment.

The example pseudocode 600 illustrates encoding categorical values using label encoding techniques. Specifically, as machine learning techniques work with numbers, all categorical and textual values are encoded into numerical values by passing the categorical values to LabelEncoder of a SciKitLearn library.

It is to be appreciated that this particular example pseudocode shows just one example implementation of encoding text-based values into numerical values, and alternative implementations of the process can be used in other embodiments.

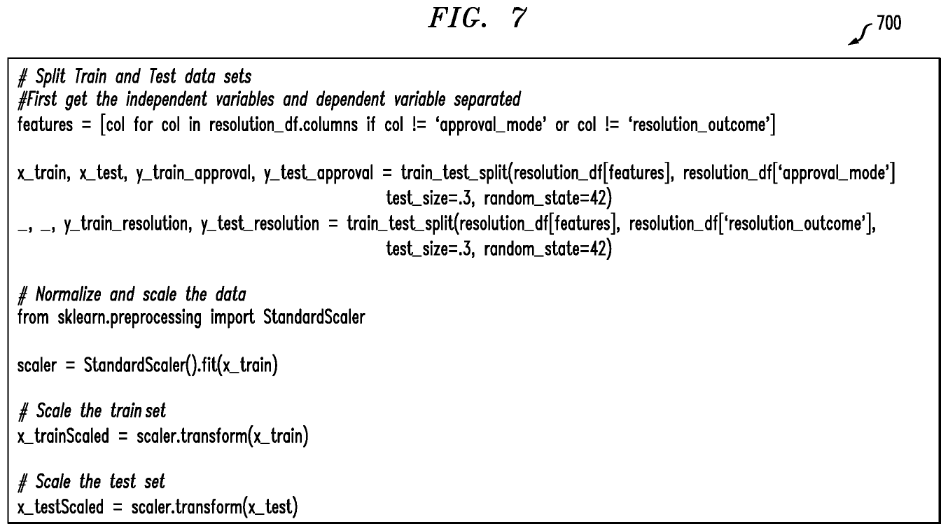

FIG. 7 shows example pseudocode for splitting a dataset into training and testing datasets in an illustrative embodiment. In this embodiment, example pseudocode 700 is executed by or under the control of at least one processing system and/or device. For example, the example pseudocode 700 may be viewed as comprising a portion of a software implementation of at least part of automated dispatch-related prediction system 105 of the FIG. 1 embodiment. The example pseudocode 700 illustrates splitting a dataset into training and testing datasets using the train test split function of a SciKitLearn library (e.g., a 70% training and 30% testing split). Considering that one or more embodiments include implementing a multi-class classification use case and a dense neural network model is used, example pseudocode 700 also illustrates scaling the data before passing the data to the model. Such scaling is performed after the training and testing dataset split is carried out, the scaling can be achieved by passing training and testing data to the StandardScaler function of a SciKitLearn library. After such data splitting and scaling, the data is ready to be used in connection with model training and testing.

It is to be appreciated that this particular example pseudocode shows just one example implementation of splitting a dataset into training and testing datasets, and alternative implementations of the process can be used in other embodiments.

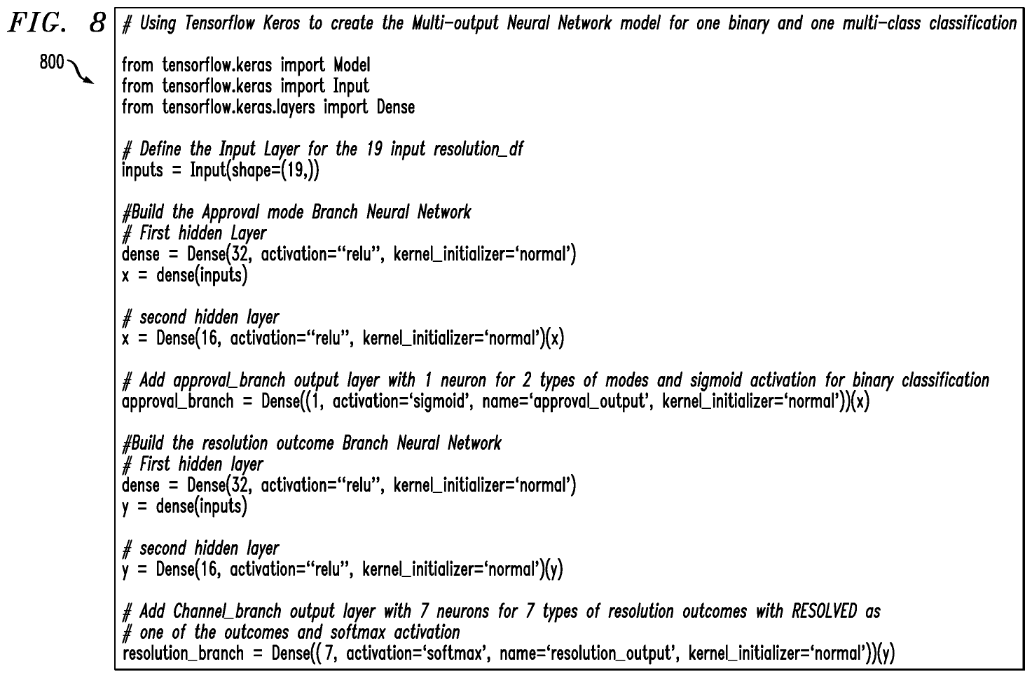

FIG. 8 shows example pseudocode for creating a neural network model in an illustrative embodiment. In this embodiment, example pseudocode 800 is executed by or under the control of at least one processing system and/or device. For example, the example pseudocode 800 may be viewed as comprising a portion of a software implementation of at least part of automated dispatch-related prediction system 105 of the FIG. 1 embodiment.

The example pseudocode 800 illustrates creating a multi-layer, multi-output capable dense neural network model using a Keras library. Such a neural network model can be built using at least one Keras functional model, as separate branches can be created and added to the functional model. For example, two separate branches of dense layers can be added to the input layer, as each branch can be used in connection with predicting different targets (e.g., approval mode and dispatch outcome).

It is to be appreciated that this particular example pseudocode shows just one example implementation of creating a neural network model, and alternative implementations of the process can be used in other embodiments.

FIG. 9 shows example pseudocode for assembling a neural network model in an illustrative embodiment. In this embodiment, example pseudocode 900 is executed by or under the control of at least one processing system and/or device. For example, the example pseudocode 900 may be viewed as comprising a portion of a software implementation of at least part of automated dispatch-related prediction system 105 of the FIG. 1 embodiment.

The example pseudocode 900 illustrates assembling a neural network model by creating a Keras functional model (e.g., as detailed in connection with FIG. 8) and passing (e.g., to the Keras function Dense(s)) the input layer as well as both branches of networks with their hidden and output layers, thereby creating the parallel network. Considering, for example, that the approval branch is designed to work as a binary classifier and the resolution branch is designed to work as a multi-class classifier, the approval branch will use binary crossentropy and the resolution branch will use categorical_crossentropy as the loss functions, respectively. Additionally, as depicted in FIG. 9, both branches can utilize Adam as the optimization function and accuracy as the metric.

It is to be appreciated that this particular example pseudocode shows just one example implementation of assembling a neural network model, and alternative implementations of the process can be used in other embodiments.

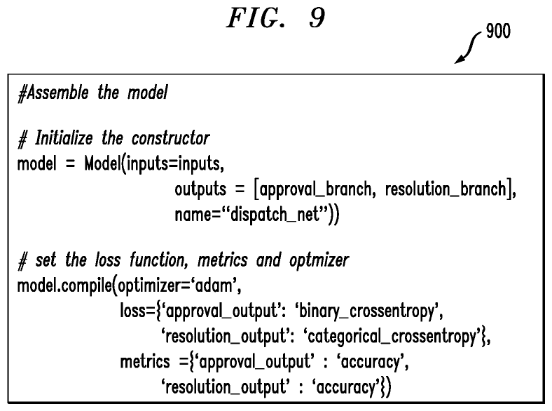

FIG. 10 shows example pseudocode for training, evaluating, and executing a neural network model in an illustrative embodiment. In this embodiment, example pseudocode 1000 is executed by or under the control of at least one processing system and/or device. For example, the example pseudocode 1000 may be viewed as comprising a portion of a software implementation of at least part of automated dispatch-related prediction system 105 of the FIG. 1 embodiment.

The example pseudocode 1000 illustrates training the model by passing the training data (both independent and dependent variable data) to the fit( ) function. Loss value is evaluated by passing the testing data to the evaluate( ) function of the trained model. Similarly, the model can be asked to predict by calling the predict( ) function and passing the appropriate input data.

It is to be appreciated that this particular example pseudocode shows just one example implementation of training, evaluating, and executing a neural network model, and alternative implementations of the process can be used in other embodiments.

It is to be appreciated that a “model,” as used herein, refers to an electronic digitally stored set of executable instructions and data values, associated with one another, which are capable of receiving and responding to a programmatic or other digital call, invocation, and/or request for resolution based upon specified input values, to yield one or more output values that can serve as the basis of computer-implemented recommendations, output data displays, machine control, etc. Persons of skill in the field may find it convenient to express models using mathematical equations, but that form of expression does not confine the model(s) disclosed herein to abstract concepts; instead, each model herein has a practical application in a processing device in the form of stored executable instructions and data that implement the model using the processing device.

FIG. 11 is a flow diagram of a process for automatically predicting dispatch-related data using machine learning techniques in an illustrative embodiment. It is to be understood that this particular process is only an example, and additional or alternative processes can be carried out in other embodiments.

In this embodiment, the process includes steps 1100 through 1106. These steps are assumed to be performed by automated dispatch-related prediction system 105 utilizing elements 112, 114 and 116.

Step 1100 includes obtaining data, from one or more user channels, pertaining to at least one issue. In at least one embodiment, obtaining data includes extracting one or more features from the data, wherein the one or more features comprise at least one of issue type, user information related to the at least one issue, product information related to the at least one issue, diagnosis information related to the at least one issue, geographic information related to the at least one issue, and warranty information related to the at least one issue. Step 1102 includes determining, based at least in part on the obtained data, that at least one dispatch is to be carried out in connection with attempting to resolve the at least one issue.

Step 1104 includes predicting, by processing at least a portion of the obtained data using one or more machine learning techniques, an approval mode associated with the at least one dispatch and at least one outcome associated with the at least one dispatch. In one or more embodiments, processing at least a portion of the obtained data using one or more machine learning techniques includes processing at least a portion of the obtained data using a multi-output neural network comprising two or more branches associated with two or more output types. In such an embodiment, the two or more branches of the multi-output neural network connect to a same input layer of the multi-output neural network. Additionally, in such an embodiment, neurons in one or more layers of the multi-output neural network use multiple types of activation functions (e.g., two or more of a rectified linear unit activation function, a sigmoid activation function, and a softmax activation function).

Also, in one or more embodiments, predicting an approval mode associated with the at least one dispatch includes determining the approval mode to be one of an automatic approval and a manual approval associated with the at least one dispatch. Additionally or alternatively, predicting at least one outcome associated with the at least one dispatch can include predicting a resolution status associated with the at least one dispatch and identifying one or more reasons associated with the predicted resolution status.

Step 1106 includes performing one or more automated actions based at least in part on one or more of the predicted approval mode and the at least one predicted outcome. In at least one embodiment, performing one or more automated actions includes automatically initiating the at least one dispatch based at least in part on the at least one predicted outcome comprising a prediction of resolution of the at least one issue in connection with the at least one dispatch. Additionally or alternatively, performing one or more automated actions includes automatically initiating at least one process for manual review of the at least one dispatch based at least in part on the at least one predicted outcome comprising a prediction of non-resolution of the at least one issue in connection with the at least one dispatch.

Also, in at least one embodiment, performing one or more automated actions includes automatically training at least a portion of the one or more machine learning techniques using feedback pertaining to one or more of the predicted approval mode and the at least one predicted outcome.

Accordingly, the particular processing operations and other functionality described in conjunction with the flow diagram of FIG. 11 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically predict dispatch-related data using machine learning techniques. These and other embodiments can effectively overcome problems associated with errors, temporal delays, and/or resource wastage.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

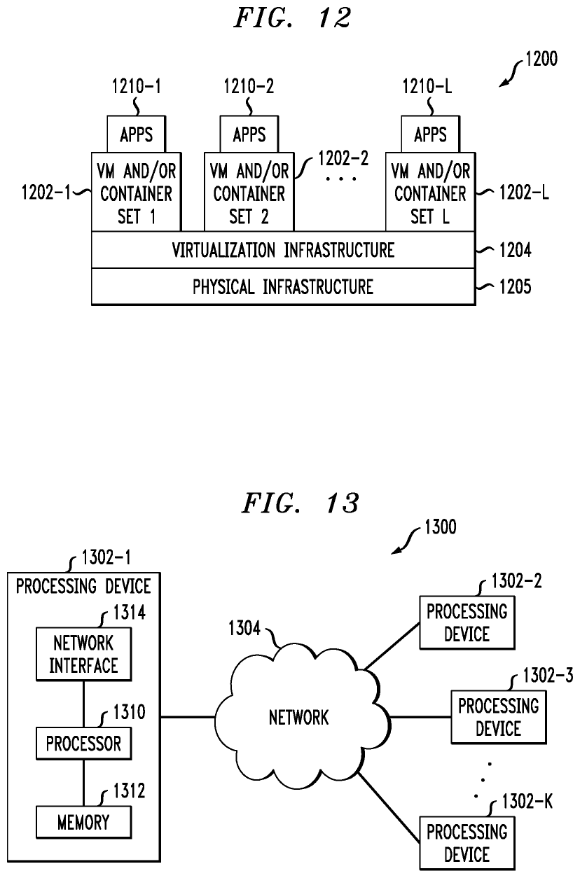

Illustrative embodiments of processing platforms will now be described in greater detail with reference to FIGS. 12 and 13. Although described in the context of system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that are utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 comprise respective VMs, respective sets of one or more containers, or respective sets of one or more containers running in VMs. In some implementations of the FIG. 12 embodiment, the VMs/container sets 1202 comprise respective VMs implemented using virtualization infrastructure 1204 that comprises at least one hypervisor.

A hypervisor platform may be used to implement a hypervisor within the virtualization infrastructure 1204, wherein the hypervisor platform has an associated virtual infrastructure management system. The underlying physical machines comprise one or more information processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of system 100 and includes a plurality of processing devices, denoted 1302-1, 1302-2, 1302-3, . . . 1302-K, which communicate with one another over a network 1304.

The network 1304 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1302-1 in the processing platform 1300 comprises a processor 1310 coupled to a memory 1312.

The processor 1310 comprises a microprocessor, a CPU, a GPU, a TPU, a microcontroller, an ASIC, a FPGA or other type of processing circuitry, as well as portions or combinations of such circuitry elements.

The memory 1312 comprises random access memory (RAM), read-only memory (ROM) or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals.

Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data, from one or more user channels, pertaining to at least one issue;
determining, based at least in part on the obtained data, that at least one dispatch is to be carried out in connection with attempting to resolve the at least one issue;
predicting, by processing at least a portion of the obtained data using one or more machine learning techniques, an approval mode associated with the at least one dispatch and at least one outcome associated with the at least one dispatch; and
performing one or more automated actions based at least in part on one or more of the predicted approval mode and the at least one predicted outcome;
wherein the method is performed by at least one processing device comprising a processor coupled to a memory.

2. The computer-implemented method of claim 1, wherein processing at least a portion of the obtained data using one or more machine learning techniques comprises processing at least a portion of the obtained data using a multi-output neural network comprising two or more branches associated with two or more output types.

3. The computer-implemented method of claim 2, wherein the two or more branches of the multi-output neural network connect to a same input layer of the multi-output neural network.

4. The computer-implemented method of claim 2, wherein neurons in one or more layers of the multi-output neural network use multiple types of activation functions.

5. The computer-implemented method of claim 1, wherein performing one or more automated actions comprises automatically initiating the at least one dispatch based at least in part on the at least one predicted outcome comprising a prediction of resolution of the at least one issue in connection with the at least one dispatch.

6. The computer-implemented method of claim 1, wherein performing one or more automated actions comprises automatically initiating at least one process for manual review of the at least one dispatch based at least in part on the at least one predicted outcome comprising a prediction of non-resolution of the at least one issue in connection with the at least one dispatch.

7. The computer-implemented method of claim 1, wherein predicting an approval mode associated with the at least one dispatch comprises determining the approval mode to be one of an automatic approval and a manual approval associated with the at least one dispatch.

8. The computer-implemented method of claim 1, wherein predicting at least one outcome associated with the at least one dispatch comprises predicting a resolution status associated with the at least one dispatch and identifying one or more reasons associated with the predicted resolution status.

9. The computer-implemented method of claim 1, wherein performing one or more automated actions comprises automatically training at least a portion of the one or more machine learning techniques using feedback pertaining to one or more of the predicted approval mode and the at least one predicted outcome.

10. The computer-implemented method of claim 1, wherein obtaining data comprises extracting one or more features from the data, wherein the one or more features comprise at least one of issue type, user information related to the at least one issue, product information related to the at least one issue, diagnosis information related to the at least one issue, geographic information related to the at least one issue, and warranty information related to the at least one issue.

11. A non-transitory processor-readable storage medium having stored therein program code of one or more software programs, wherein the program code when executed by at least one processing device causes the at least one processing device:
to obtain data, from one or more user channels, pertaining to at least one issue;
to determine, based at least in part on the obtained data, that at least one dispatch is to be carried out in connection with attempting to resolve the at least one issue;
to predict, by processing at least a portion of the obtained data using one or more machine learning techniques, an approval mode associated with the at least one dispatch and at least one outcome associated with the at least one dispatch; and
to perform one or more automated actions based at least in part on one or more of the predicted approval mode and the at least one predicted outcome.

12. The non-transitory processor-readable storage medium of claim 11, wherein processing at least a portion of the obtained data using one or more machine learning techniques comprises processing at least a portion of the obtained data using a multi-output neural network comprising two or more branches associated with two or more output types.

13. The non-transitory processor-readable storage medium of claim 12, wherein the two or more branches of the multi-output neural network connect to a same input layer of the multi-output neural network.

14. The non-transitory processor-readable storage medium of claim 11, wherein performing one or more automated actions comprises automatically initiating the at least one dispatch based at least in part on the at least one predicted outcome comprising a prediction of resolution of the at least one issue in connection with the at least one dispatch.

15. The non-transitory processor-readable storage medium of claim 11, wherein performing one or more automated actions comprises automatically initiating at least one process for manual review of the at least one dispatch based at least in part on the at least one predicted outcome comprising a prediction of non-resolution of the at least one issue in connection with the at least one dispatch.

16. An apparatus comprising:
at least one processing device comprising a processor coupled to a memory;
the at least one processing device being configured:
to obtain data, from one or more user channels, pertaining to at least one issue;
to determine, based at least in part on the obtained data, that at least one dispatch is to be carried out in connection with attempting to resolve the at least one issue;
to predict, by processing at least a portion of the obtained data using one or more machine learning techniques, an approval mode associated with the at least one dispatch and at least one outcome associated with the at least one dispatch; and
to perform one or more automated actions based at least in part on one or more of the predicted approval mode and the at least one predicted outcome.

17. The apparatus of claim 16, wherein processing at least a portion of the obtained data using one or more machine learning techniques comprises processing at least a portion of the obtained data using a multi-output neural network comprising two or more branches associated with two or more output types.

18. The apparatus of claim 17, wherein the two or more branches of the multi-output neural network connect to a same input layer of the multi-output neural network.

19. The apparatus of claim 16, wherein performing one or more automated actions comprises automatically initiating the at least one dispatch based at least in part on the at least one predicted outcome comprising a prediction of resolution of the at least one issue in connection with the at least one dispatch.

20. The apparatus of claim 16, wherein performing one or more automated actions comprises automatically initiating at least one process for manual review of the at least one dispatch based at least in part on the at least one predicted outcome comprising a prediction of non-resolution of the at least one issue in connection with the at least one dispatch.
